(19) United States
(12) Patent Application Publication
(10) Pub. No.: US 2019/0095530 A1
(43) Pub. Date: Mar. 28, 2019

(54) TAG RELATIONSHIP MODELING AND PREDICTION

(71) Applicant: Estia, Inc., San Antonio, TX (US)

(72) Inventors: Austin Avery Booker, San Antonio, TX (US); Estefan Miguel Ortiz, San Antonio, TX (US); Nakul Jeirath, San Antonio, TX (US); Augustine Vidal Pedraza, IV, San Antonio, TX (US)

(21) Appl. No.: 16/137,872

(22) Filed: Sep. 21, 2018

Related U.S. Application Data
(60) Provisional application No. 62/561,937, filed on Sep. 22, 2017.

(51) Int. Cl. G06F 17/30; G06F 15/18; G06Q 50/00

(52) U.S. Cl. CPC G06F 17/30864; G06F 17/30616; G06Q 50/01; G06F 15/18; G06F 17/30958

(57) ABSTRACT

Techniques are described for generating graphs that describe relationships between tags included in items published on a network, and for analyzing the graphs to develop a model that describes the changes in relationships between tags over time. Implementations provide an analysis platform in which published items are analyzed, using machine learning-trained model(s), to model and predict relationships between tags and/or changes in the strength and presence of the relationships between tags. The relationships between tags can be used to generate one or more graphs. Through graph-based modeling of the manner in which correlated pairs of tags change in the strength of their correlation (e.g., their relationship strength) over time, implementations can generate predictions regarding how a correlation between tags is likely to change in the future, and can also generate recommendations regarding how a particular correlation may be maintained over time.

### CROSS-REFERENCE TO RELATED APPLICATION

The present disclosure is related to, and claims priority to, U.S. Provisional Patent Application Ser. No. 62/561,937, titled “Tag Relationship Modeling And Prediction,” which was filed on Sep. 22, 2017, and the entirety of which is incorporated by reference into the present disclosure.

### BACKGROUND

As the amount of information published on social networks has increased, organizations have developed various channels that attempt to use information published online to promote brands or other topics. Traditional marketing or advertising techniques have employed a generally unfocused approach in which information is indiscriminately sent to a large population of individuals. Given this unfocused approach, such efforts may fail to effectively promote a topic (e.g., brand) or reach new audiences, leading to a diminished return on investment in marketing or advertising campaigns. Accurate targeting of marketing efforts may be further hindered by a lack of accurate information regarding individuals who post on social networks.

### SUMMARY

Implementations of the present disclosure are generally directed to analyzing items published on networks. More particularly, implementations of the present disclosure are directed to developing network graphs that describe relationships between tags included in published items, and analyzing the network graphs to develop models that predict the changes in tag-to-tag relationships over time.

In general, implementations of innovative aspects of the subject matter described in this specification can be embodied in methods that include actions of: receiving items that are published on a network, each of the items including one or more tags specified by an author of a respective item; analyzing the items to determine a plurality of graphs, wherein each graph models co-occurrences, during a respective time period, of pairs of tags in the items, each of the graphs including: a plurality of nodes, each node corresponding to a tag that is included in the items published during the respective time period, and one or more edges, each edge having a weight that indicates a number of co-occurrences of a respective pair of tags in the items published during the respective time period; generating a model that describes one or more changes, over time, in the plurality of graphs; and employing the model to predict the number of future co-occurrences of at least one pair of tags in items that are subsequently published on the network.

These and other implementations can each optionally include one or more of the following innovative aspects: a first graph of the plurality of graphs models co-occurrences, during a first time period after an event, of the pairs of tags in the items; at least one second graph of the plurality of graphs models co-occurrences, during at least one second time period after the first time period, of the pairs of tags in the items; the model describes the one or more changes in the number co-occurrences of the at least one pair of tags following the event; the model is employed to predict how long a pair of tags exhibit at least one co-occurrence in the subsequently published items; the actions further include employing the model to predict a future value that is created, over time, by at least one co-occurring pair of tags; the one or more tags include one or more hashtags; the at least one network includes a social network; and/or the published items are published as one or more of a tweet, a post, a share, or a comment on the social network.

Other implementations of any of the above aspects include corresponding systems, apparatus, and computer programs that are configured to perform the actions of the methods, encoded on computer storage devices. The present disclosure also provides a computer-readable storage medium coupled to one or more processors and having instructions stored thereon which, when executed by the one or more processors, cause the one or more processors to perform operations in accordance with implementations of the methods provided herein. The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

Implementations of the present disclosure provide one or more of the following technical advantages and improvements over traditional systems. Implementations provide a platform that models and predicts the dynamic network behavior and relationships between tags (e.g., co-occurrences of tags). Implementations provide modeling and visualization of how those connections (relationships) change over time, and enable more accurate targeting of advertising or marketing campaigns on networks such as social networks, and also enable the fine-tuning of such campaigns to more efficiently maintain positive correlations (and/or degrade negative correlations) between tags. Additionally, implementations include methods to use measures of network size and growth per unit time to observe effectiveness of a given campaign, event, brand awareness, and/or overall brand presence and growth of a given brand. Implementations can use network size and network growth as a basis by which to compare brands, their campaigns, products, audience growth or decline, and resonance within a given social network. Accordingly, implementations avoid the unnecessary expenditure of processing power, memory, storage space, network bandwidth, and/or other computing resources that traditional systems may expend through inaccurately targeted or otherwise inefficient campaigns on social networks.

Various examples herein describe modeling based on the tags in published items, through an examination of hashtags, their co-occurrence, and their associated timestamps to establish the dynamic network. However, implementations are not limited to tag-based analysis. In some implementations, one or more topics can be inferred from the text of a given post and/or from features extracted from images during a preprocessing phase, each text item or image feature associated with the timestamp from the original posted item. Dynamic networks can be determined based on co-occurring topics as well as co-occurring image features.

It is appreciated that implementations in accordance with the present disclosure can include any combination of the aspects and features described herein. That is, implementations in accordance with the present disclosure are not limited to the combinations of aspects and features specifically described herein, but also include any other appropriate combinations of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 depicts an example system for performing a graph-based analysis of items published to networks, according to implementations of the present disclosure.

FIG. 2 depicts an example graph describing relationships between tags included in published items, according to implementations of the present disclosure.

FIG. 3 depicts example graphs that describe a variation, over time, in the relationships between tags included in published items, according to implementations of the present disclosure.

FIG. 4 depicts an example prediction for future changes in the strength of a relationship between tags, according to implementations of the present disclosure.

FIG. 5 depicts a flow diagram of an example process for performing a graph-based analysis of items published to networks, according to implementations of the present disclosure.

FIG. 6 depicts an example computing system, according to implementations of the present disclosure.

### DETAILED DESCRIPTION

Implementations of the present disclosure are directed to systems, devices, methods, and computer-readable media for generating graphs that describe relationships between tags included in items published on a network, and for analyzing the graphs to develop a model that describes the changes in relationships between tags over time. As used herein, a graph describes a network graph that may correspond to a mathematical structure that describes pair-wise relationships between pairs of a plurality of objects. Implementations provide an analysis platform in which published items are analyzed, using machine learning-trained model(s), to model and predict relationships between tags and/or changes in the strength and presence of the relationships between tags. The platform receives items that are published on a network, such as a social network. The items may include posts, tweets, comments, reviews, and so forth. The items can each include one or more tags that have been added to the item by an author of the item, to provide a topic and/or additional context for the item, to associate the item with other items related to the same topic, to emphasize certain words or phrases in the item, and/or for other purposes. The platform can analyze the occurrences of the tags in the items, and determine instances when a pair of tags is included in one or more of the same items. A pair of tags are described as being related, and/or exhibiting a relationship, if the pair of tags exhibit one or more co-occurrences in one or more items.

The relationships between tags can be used to generate one or more graphs. Each graph includes a plurality of nodes, where each node corresponds to a tag. An edge between nodes indicates a relationship between the two tags corresponding to the nodes joined by the edge, and indicates that two tags co-occur in at least one published item. An edge may have a weight that corresponds to the number (e.g., frequency) of co-occurrences of the pair of tags in published items, during the period of time corresponding to the graph. In some implementations, multiple graphs are generated, where each graph indicates relationships between tags present in items that are published during a period of time. Accordingly, the graphs depict a change over time in the relationships between tags (e.g., in an ecosystem of tags), such that one or more of the edges exhibit a change in weight (increase or decrease) from graph to graph. In some instances, an edge that is present in one graph may not be present in a subsequent graph, indicating that the relationship between the previously joined tags is no longer present in the published items after a time. In some instances, an edge that is not present in one graph may be present in a subsequent graph, indicating that previously absent relationship between two tags comes into existence at some time.

In some instances, the tags that are included in the published items, and that are analyzed by the platform, are tags that have been added to the item(s) by the author(s) of the items. In some instances, the tags may include one or more control characters that designate the subsequent, preceding, or otherwise proximal text as a metadata tag. For example, a tag may be designated with a starting character “#”. Such tags may be referred to as hashtags, such as those used on various social network and/or microblogging services. Other types of tags can also be analyzed by the platform described herein. The control characters that designate a tag may be at the beginning of a tag as a prefix character (e.g., #tag), at the end of a tag as a suffix character (e.g., tag#), and/or bracketing the tag to indicate both the beginning and the end of the tag (e.g., #tag#).

In some implementations, the graphs describing a group of tags may be analyzed to generate one or more models. Such models are trained using a suitable machine learning technique, and can be predictive models that are used to predict future changes in relationships between pairs of tags. The models can be used to generate predictions and/or recommendations that are provided to data consumer(s) in report(s), as described further below.

Implementations employ graph-based analysis to describe a network of tags, and to determine how a network of tags can assemble, dissipate, and/or change the weight of relationships between tags over a period of time. Edges between tags may form, or dissipate, as co-occurrences between tags become present, or are no longer present, within a network of tags. Such graph-based analysis can be used to develop models that predict how a network of tags may change in the future, based on observations of how such networks changed in the past.

In some instances, an analysis may begin with a first time period that includes (or starts with) the time of a particular event. For example, a car show event may cause many individuals on a social network to post regarding the car show, and such posts may include various hashtags related to the event. As a particular example, a car show in Munich may feature products (e.g., automobiles, vehicle accessories, etc.) of a particular brand of luxury automobile (e.g., ALV). At the time of the show, or shortly thereafter, individuals on social networks may publish items regarding the show and/or the brand, and such items may include frequent co-occurrences of pairs of tags in the group of tags that include #alv, #alvmunich, #luxury, #luxuryalv, #alv123 (e.g., for a particular model 123), and so forth. Frequent co-occurrences of pairs of the tags in published items may demonstrate a strong correlation between certain tags, indicating that the brands and/or concepts corresponding to the co-occurring tags are strongly related in people's minds. As time passes following the show, certain relationships between pairs of tags may degrade, based on a decreasing frequency of co-occurrences of the pairs of tags. Such a weakening of a correlation over time may indicate that the brands and/or concepts are less strong related in people's minds as the memory of the events fades into the past.

By modeling the manner in which correlated pairs of tags change in the strength of their correlation (e.g., their relationship strength) over time, implementations can generate predictions regarding how a correlation between tags is likely to change in the future. Implementations can also generate recommendations regarding how a particular correlation may be maintained over time, for example if it is a positive correlation (e.g., brand name associated with luxury, happiness, wealth, goodness, etc.) that a data consumer (e.g., brand owner) may wish to preserve in people's minds. In some instances, recommendations may be generated to help a data consumer speed the degradation of a negative correlation, if that correlation is undesirable to a data consumer.

In some implementations, a value can be determined based on an existence of a relationship (e.g., correlation) between a pair of tags. Such a value can be positive, if the association is positive. For example, a relationship between a brand and a positive concept (e.g., luxury, wealth, happiness, health, etc.) can have a positive value, given that more individuals may buy the brand if it is associated with positive concepts. In some instances, a relationship between a brand and a negative concept (e.g., shoddiness, sadness, sickness, etc.) can have a negative value, given that fewer individuals may buy the brand if it is associated with negative concepts. The persistence and/or change in a relationship between tags can therefore be translated to a change in value over time and/or a total integrated value (positive or negative) over a period of time. Accordingly, the cost of creating an event (e.g., fashion show, car show, marketing campaign, advertising campaign, etc.) can be compared to the predicted value that the event generates through spawned and (at least temporarily) persisting relationships between pairs of tags. A recommendation can be made whether a particular event is worth its cost, given the predicted return on investment generated by tag-to-tag relationships created and/or changed through the publicity (e.g., buzz) from the event. Recommendations can also be generated to advise a data consumer (e.g., a brand manager for a company brand) what events may be created to generate and/or preserve positive (e.g., profitable) links between tags, and/or what events may be created to destroy or at least degrade negative (e.g., unprofitable) links between certain tags.

In some implementations, the value of a relationship between tags, and therefore the predicted return on investment (ROI) for establishing and/or maintaining the relationship, is based on the persistent association of a tag or set of tags with a given concept (e.g., luxury, quality, etc.). Overall network growth (e.g., hashtag, topic, image features, etc.) can also be used to measure overall ROI. The network size can be measured before an event or campaign occurs, and the network size can be tracked to determine effectiveness or ROI of an event or campaign over time.

An event may also be described as a trigger that creates an impulse response in individuals, causing them to publish items on a social network that include pairs of tags. The co-occurrence(s) of pair(s) of tags in published items may indicate that the tags are associated with concepts are related in the authors' minds, in general or in particular following the triggering event. The tag network (e.g., correlated group of tags) may evolve after the triggering event, as certain correlations degrade, vanish, come into existence, and/or grow in strength. Each graph may describe the state of a tag network during a period of time. Accordingly, the set of graphs may be described as a time series or collection of time series, where each graph describes the tag network at a point in time (or a period of time) in the series, and/or where each edge in the graph describes the strength of a relationship between a pair of tags at a point in time (or a period of time). The zero time of the series may be the triggering event.

In some instances, a certain group of tags may cluster (e.g., form correlations) without being caused by any particular triggering event. Some correlations may simply indicate a persistent association of concepts, such as a correlation between #waikiki, #beach, and #vacation for many individuals. In some implementations, such persistent, event-independent correlations may be filtered out as a pre-processing step in the analysis, such that the graphs include those correlations that are event-triggered and/or changeable over time.

Predictions that are performed based on the set of graphs may include one or more of the following: a prediction of the occurrence, or disappearance, of correlations between tags; a prediction of the weight of a correlation between tags, indicating a number (e.g., frequency) of co-occurrences of a pair of tags in published items; a prediction of the change in the weight, over time, of a correlation between tags.

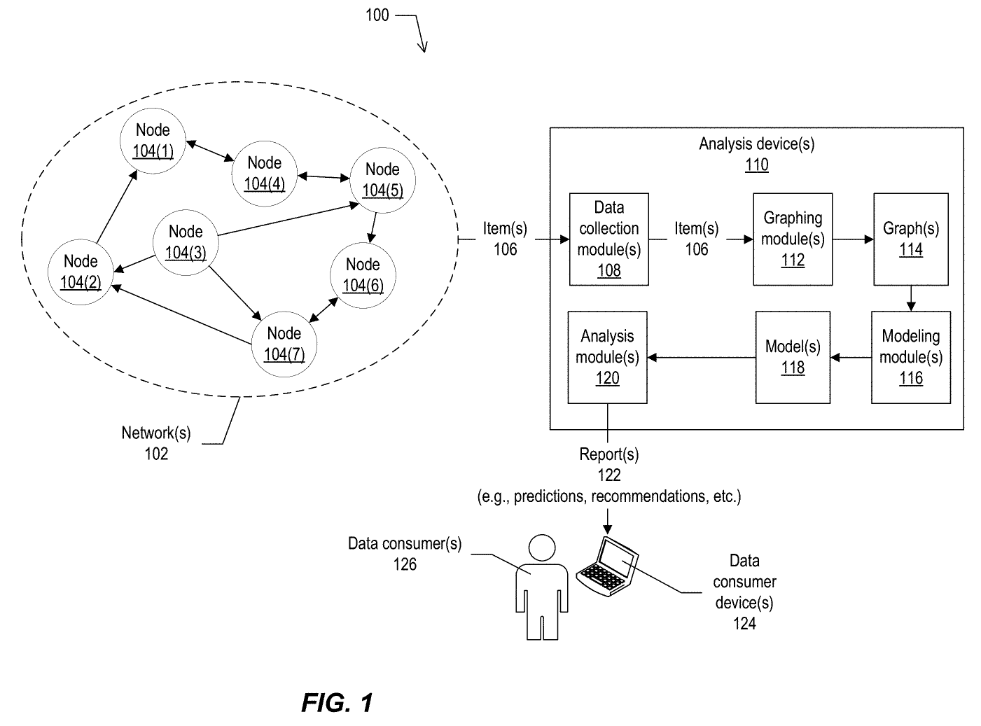

FIG. 1 depicts an example system 100 for performing a graph-based analysis of items published to networks, according to implementations of the present disclosure. As shown in the example of FIG. 1, the environment may include one or more networks 102. The network may include any number of nodes 104 that are able to communicate with one another through the network 102. In some instances, a node 104 may be a user of the network 102. A network 102 may include any type of network in which user(s) (e.g., individual(s), author(s)) may publish item(s) to be viewed by other user(s). In some instances, the published item(s) may be republished by the user(s) on the network, and/or published to other network(s). In some instances, a network 102 may be a social network in which users communicate with other users via published items. A network 102 may include users who have registered with the network 102, such that the users have accounts, profiles, or other forms of presence in the network 102. Examples of a network 102 may include Facebook™, Twitter™, Instagram™, Pinterest™, Weibo™, WeChat™, Alibaba™, or others. A network 102 may be public, such that any user may be allowed to publish, view, and republish items. A network 102 may be, to some extent, private, such that a subset of the general public is allowed to publish, view, and republish items.

A user may publish item(s) 106 that may be viewable and/or republishable by other user(s) in the same network 102 and/or other network(s). A network 102 may employ any data suitable format or arrangement of data for published items 106, and published items 106 may be communicated within the network 102 using any suitable communication protocol. A published item may include one or more types of data, including but not limited to text data, graphics, images, videos, audio data, and so forth. The publishing user may be associated with a set of followers, e.g., other user(s) in the network 102. A follower of a publishing user may include a user who has indicated a desired to view published item(s) 106 of the publishing user 104. For example, a follower may edit their user profile or account information to follow the publishing user, and subsequently the follower may receive notifications indicating when the publishing user publishes an item 106. A follower may be variously described in different social networks as a follower, a friend, a contact, a link, a fan, and so forth.

The followers of the publishing user 104 may also republish the original published item(s) 106 of the publishing user. Republication may include, but is not limited to, sharing, reposting, retweeting, or commenting on the published item 106, such that the published item 106 may then be viewed by other users. Republication may include republication of the published item 106 in its entirety, or republication of any portion of the published item 106 (e.g., as an excerpt). A follower of the publishing user may republish an item 106 such that the item 106 is viewable by other users who are followers of the republishing user. Any number of those followers may then republish the item 106 to be viewable by other, who may themselves republish the item 106, and so on to any number of republication levels. In this way, a published item 106 may propagate through a network 102. Each set of republications by one or more republishing users may be described as a ripple of the published item 106 as it propagates within the network 102.

Although examples herein may describe users viewing an item that is published in a network 102, implementations are not limited to item(s) 106 that are visually presented to users in the form of text data, image data, video data, and so forth. An item 106 may also be presented, at least in part, as audio data, haptic data (e.g., vibrations or other movements of a computing device), or via other modes of presentation.

As shown in the example of FIG. 1, the environment may include one or more analysis computing devices 110, which may include any suitable number and type of computing device. The analysis computing device(s) 110 may be described as a platform for predicting location and/or other characteristics for published items. The analysis computing device(s) 110 may execute any suitable number of software module(s), which may be described as an analysis engine and/or platform.

The analysis computing device(s) 110 may execute one or more data collection module(s) 108 which collect information regarding one or more network(s) 102. The data collection module(s) 108 may retrieve and store one or more published item(s) 106 published on the network(s) 102. The data collection module(s) 108 may also retrieve metadata describing the published item(s) 106, including but not limited to a timestamp (e.g., date and/or time) of publication, the publishing user, a subject line, title, or summary of the item 106 as published, a category of the item 106, and/or other metadata such as tags, hashtags, and so forth. The data collection module(s) 108 may also retrieve and store other information available in the network(s) 102, such as demographic information regarding the user(s) who publish item(s) 106, where such demographic information is available. Demographic information may include various user characteristics, including but is not limited to one or more of the following: user location (e.g., to any degree of specificity), age, gender, ethnic identification, spoken language(s), profession, hobbies, interests, income level, purchase history, group affiliation(s), education level, or other characteristics.

The item(s) 106 may be received by one or more graphing modules 112 executed by the analysis device(s) 110. The graphing module(s) 112 may generate one or more graphs 114 that each describes a set of relationships between pairs of the tags included in the published items 106. In some implementations, each graph may describe a set of relationships between tags that are present, in the published items, at a particular time and/or during a period of time, such that each graph provides a view of a tag network of interrelated tags at the particular time and/or during the particular period of time. The graph(s) 114 may be stored in memory on the analysis device(s) 110 or elsewhere.

The graph(s) 114 may be received by one or more modeling modules 116 executing on the analysis device(s) 110. The modeling module(s) 116 may analyze the graph(s) 114 to generate one or more models 118. Each model 118 may describe how a graph changes over time, and/or how one or more particular correlations (e.g., edges) between pairs of tags changes over time. The modeling module(s) 116 may employ any suitable machine learning techniques to develop the model(s) 118. In some implementations, unsupervised machine learning techniques are employed to determine clusters of nodes that are connected to one another or to a particular concept. For prediction tasks of network growth or expected number of clusters per unit time, time series analysis and modeling (ARIMA, adaptive filter methods, statistical signal processing) can be used. In the example of determining a classification of a network or cliques within a network, supervised machine learning models are applied. This can include the determination of class label per network or clique and associating that label to features extracted from the network as whole as well as features extracted from detailed content. The model(s) 118 may be stored in memory on the analysis device(s) 110 or elsewhere.

The model(s) 118 may be received by one or more analysis modules 120 executing on the analysis device(s) 110. The analysis module(s) 120 may analyze the model(s) 118 to generate predictions and/or recommendations regarding tag correlations, as described above. The predictions and/or recommendations may be provided, in report(s) 122, that are sent to data consumer device(s) 124 operated by data consumer(s) 126. The report(s) 122 may be presented, through the data consumer device(s) 124, to the data consumer(s) 126. The data consumer device(s) 124 may include any suitable type of computing device, including portable (e.g., mobile) computing device(s) (e.g., smartphone, tablet computer, wearable computer, etc.) as well as less portable computing device(s) (e.g., desktop computer, laptop computer, etc.).

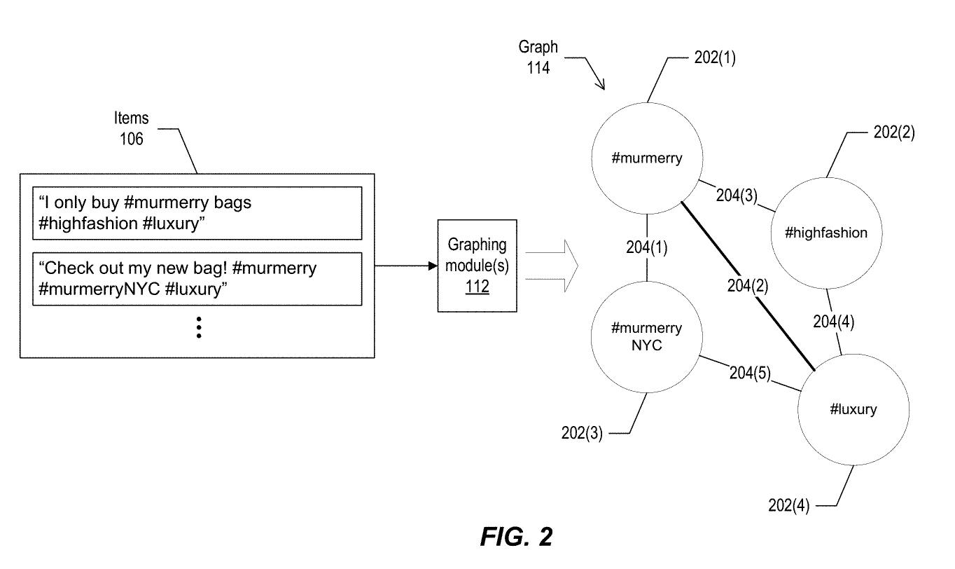

FIG. 2 depicts an example graph 114 describing relationships between tags included in published items, according to implementations of the present disclosure. As shown in this example, published items 106 are received by the graphing module(s) 112 and used to generate graph(s) 114. A graph 114 may include any suitable number of nodes 202, where each node corresponds to a particular tag that is present in the item(s) 106. The graph 114 may also include any suitable number of edges 204, where each edge connects two nodes 202, thus indicating a relationship between the two tags corresponding to the connected nodes 202. As described above, a relationship is present between two tags if there is at least one item 106 in which the two tags are both present (e.g., co-occur). In some implementations, a weight of an edge 204 indicates a strength of the relationship between the two corresponding tags, the strength being a number (e.g., frequency) of co-occurrences of the two corresponding tags. In the example shown, the tags “#murmerry” and “#luxury” occur in two example items, and the edge 204(2) that joins the nodes 202 corresponding to these tags has a greater weight than the other edges that indicate a single co-occurrence of tags. In some implementations, the absence of an edge 204 connecting two nodes 202 indicates that the two corresponding tags do not co-occur in any of the items 106 being analyzed, at least during the particular period of time (or at the particular instant in time) corresponding to the graph 114. Although the example graph of FIG. 2 includes four nodes and five edges, implementations support the development and analysis of graphs that include any appropriate number of nodes and/or edges.

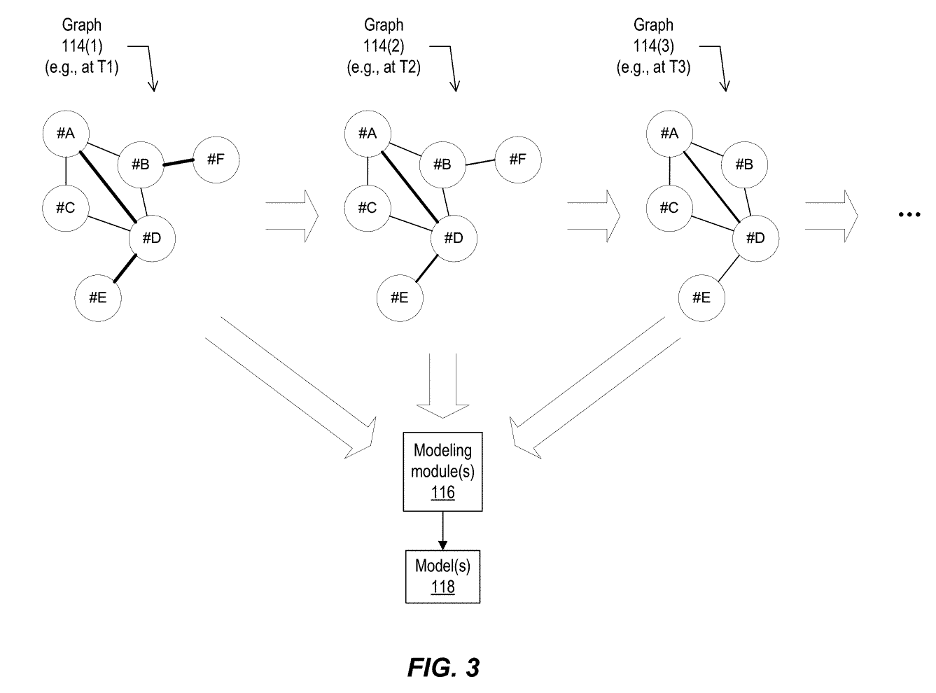

FIG. 3 depicts example graphs 114 that describe a variation, over time, in the relationships between tags included in published items, according to implementations of the present disclosure. In this example, a set of three graphs 114 describe a tag network of multiple tags at various times T1, T2, and T3. In some instances, a graph corresponds to a point in time, such that the graph describes the relationships between tags that are present in items that are published on the network at that point in time. In some instances, a graph corresponds to a period of time, such that the graph describes the relationships between tags that are present in items that are published on the network during that period of time. In some instances, a set of graphs may depict changes in a tag network from time to time, or from time period to time period, in a direction of forward progressing time or backward receding time, such that the set of graphs depicts an evolution in the tag network forward in time, or a devolution in the tag network backward in time.

In the particular example of FIG. 3, the edge that connects nodes for tags #A and #D appears to degrade over time, such that the weight of the edge decreases from graph to graph. Similarly, the edge that connects nodes for tags #E and #D also appears to degrade over time. The edge that connects nodes for tags #B and #F degrades over time to the extent that the edge disappears in the third graph, indicating that the #B and #F tags do not co-occur in any items that are published at (or during) time T3. Any suitable number of graphs 114 may be generated and analyzed, spanning any suitable period of time. The various graphs 114 may be received by the modeling module(s) 116 and used to generate the model(s) 118 that describe, and predict, how the graphs change over time, and/or how particular elements of the graphs (e.g., nodes and/or edges) change over time.

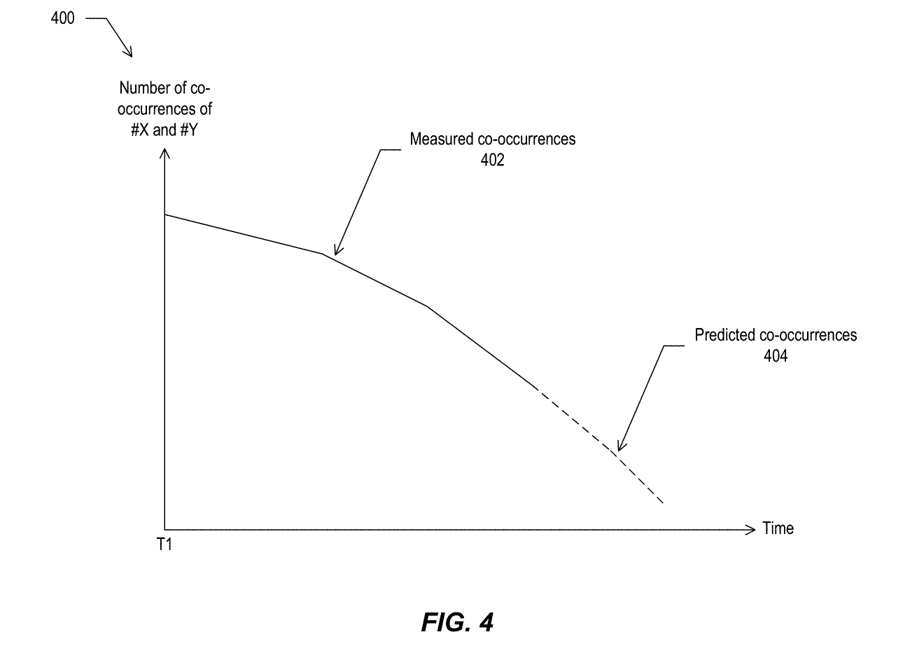

FIG. 4 depicts an example prediction 400 for future changes in the weight (e.g., strength) of a relationship between tags, according to implementations of the present disclosure. As shown in this example, a particular edge in the graphs 114 is analyzed, the edge that indicates a number of co-occurrences between two tags #X and #Y. The measured co-occurrences 402 may be determined based on the observed number of co-occurrences that are present in the items 106 that are received and analyzed by the platform. The analysis module(s) 120 may determine (e.g., predict) the predicted co-occurrences 404 of the tags at one or more times (or periods of time) in the future, beyond the period(s) of time covered by the received items 106. The prediction may be based on the measured co-occurrences 402, and in some instances may be an extrapolation of the measured co-occurrences that is performed based on the model(s) 118.

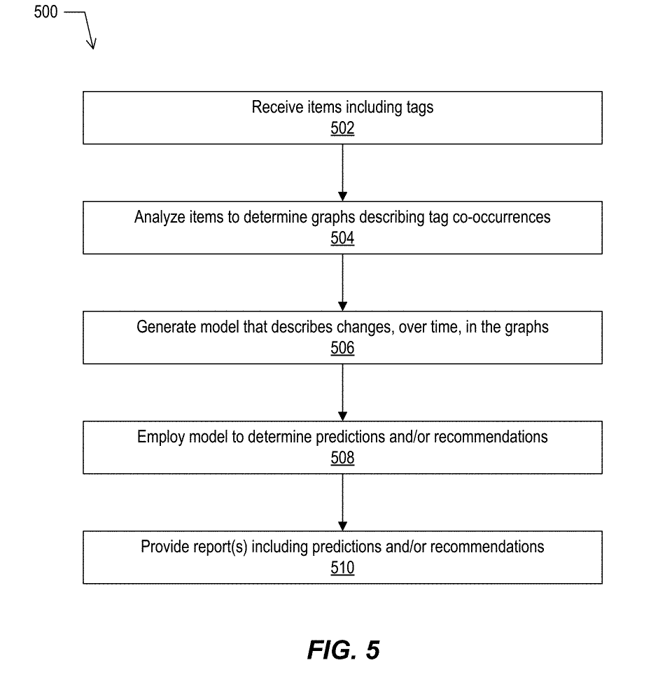

FIG. 5 depicts a flow diagram of an example process 500 for performing a graph-based analysis of items published to networks, according to implementations of the present disclosure. Operations of the process may be performed by one or more of the data collection module(s) 108, the graphing module(s) 112, the modeling module(s) 116, the analysis module(s) 120, and/or other software module(s) executing on the analysis device(s) 110 or elsewhere.

The items 106 are received (502). As described above, each of the items may include one or more tags (e.g., hashtags) that have been added to the item by an author of the item, such as the individual who posted the item to a social network. The items 106 are analyzed (504) to determine one or more graphs 114. The graph(s) 114 may each describe a tag network at a time or period of time, depicting the various relationships (edges) and relationship strengths (weights) between pairs of the tags present in the items. The graph(s) 114 are analyzed to generate (506) model(s) 118. The model(s) 118 may be predictive model(s) that are usable to predict future changes in the tag network, including the increase or decrease in strength of tag-to-tag relationships, and/or the appearance or disappearance of relationships and/or tags within the network. The model(s) 118 are employed (508) to determine predictions and/or recommendations, which are provided (510) in report(s) 122 to data consumer(s) 126. A data consumer 126 may be any individual and/or entity (e.g., company) that receives the report(s) 122. For example, a data consumer 126 may be a brand manager, marketing specialist, advertising campaign designer, and/or other individual or group of individuals with an interest in understanding how tag networks evolve.

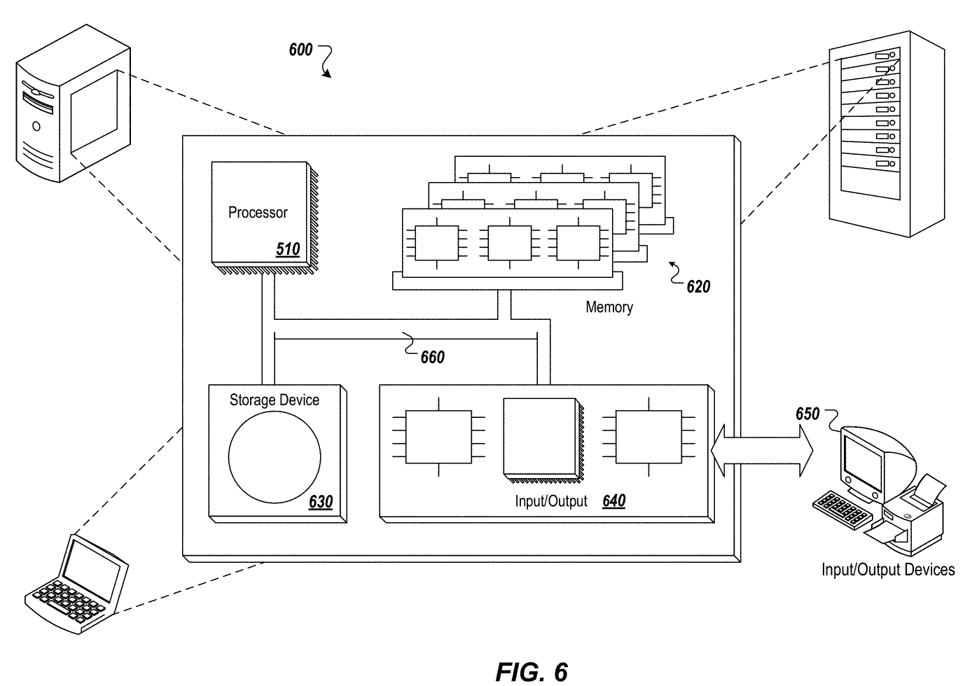

FIG. 6 depicts an example computing system 600, according to implementations of the present disclosure. The system 600 may be used for any of the operations described with respect to the various implementations discussed herein. For example, the system 600 may be included, at least in part, in the analysis computing device(s) 110, data consumer device(s) 124, and/or other computing device(s) or system(s) described herein. The system 600 may include one or more processors 610, a memory 620, one or more storage devices 630, and one or more input/output (I/O) devices 650 controllable via one or more I/O interfaces 640. The various components 610, 620, 630, 640, or 650 may be interconnected via at least one system bus 660, which may enable the transfer of data between the various modules and components of the system 600.

The processor(s) 610 may be configured to process instructions for execution within the system 600. The processor(s) 610 may include single-threaded processor(s), multi-threaded processor(s), or both. The processor(s) 610 may be configured to process instructions stored in the memory 620 or on the storage device(s) 630. For example, the processor(s) 610 may execute instructions for the various software module(s) described herein. The processor(s) 610 may include hardware-based processor(s) each including one or more cores. The processor(s) 610 may include general purpose processor(s), special purpose processor(s), or both.

The memory 620 may store information within the system 600. In some implementations, the memory 620 includes one or more computer-readable media. The memory 620 may include any number of volatile memory units, any number of non-volatile memory units, or both volatile and non-volatile memory units. The memory 620 may include read-only memory, random access memory, or both. In some examples, the memory 620 may be employed as active or physical memory by one or more executing software modules.

The storage device(s) 630 may be configured to provide (e.g., persistent) mass storage for the system 600. In some implementations, the storage device(s) 630 may include one or more computer-readable media. For example, the storage device(s) 630 may include a floppy disk device, a hard disk device, an optical disk device, or a tape device. The storage device(s) 630 may include read-only memory, random access memory, or both. The storage device(s) 630 may include one or more of an internal hard drive, an external hard drive, or a removable drive.

One or both of the memory 620 or the storage device(s) 630 may include one or more computer-readable storage media (CRSM). The CRSM may include one or more of an electronic storage medium, a magnetic storage medium, an optical storage medium, a magneto-optical storage medium, a quantum storage medium, a mechanical computer storage medium, and so forth. The CRSM may provide storage of computer-readable instructions describing data structures, processes, applications, programs, other modules, or other data for the operation of the system 600. In some implementations, the CRSM may include a data store that provides storage of computer-readable instructions or other information in a non-transitory format. The CRSM may be incorporated into the system 600 or may be external with respect to the system 600. The CRSM may include read-only memory, random access memory, or both. One or more CRSM suitable for tangibly embodying computer program instructions and data may include any type of non-volatile memory, including but not limited to: semiconductor memory devices, such as EPROM, EEPROM, and flash memory devices; magnetic disks such as internal hard disks and removable disks; magneto-optical disks; and CD-ROM and DVD-ROM disks. In some examples, the processor(s) 610 and the memory 620 may be supplemented by, or incorporated into, one or more application-specific integrated circuits (ASICs).

The system 600 may include one or more I/O devices 650. The I/O device(s) 650 may include one or more input devices such as a keyboard, a mouse, a pen, a game controller, a touch input device, an audio input device (e.g., a microphone), a gestural input device, a haptic input device, an image or video capture device (e.g., a camera), or other devices. In some examples, the I/O device(s) 650 may also include one or more output devices such as a display, LED(s), an audio output device (e.g., a speaker), a printer, a haptic output device, and so forth. The I/O device(s) 650 may be physically incorporated in one or more computing devices of the system 600, or may be external with respect to one or more computing devices of the system 600.

The system 600 may include one or more I/O interfaces 640 to enable components or modules of the system 600 to control, interface with, or otherwise communicate with the I/O device(s) 650. The I/O interface(s) 640 may enable information to be transferred in or out of the system 600, or between components of the system 600, through serial communication, parallel communication, or other types of communication. For example, the I/O interface(s) 640 may comply with a version of the RS-232 standard for serial ports, or with a version of the IEEE 1284 standard for parallel ports. As another example, the I/O interface(s) 640 may be configured to provide a connection over Universal Serial Bus (USB) or Ethernet. In some examples, the I/O interface(s) 640 may be configured to provide a serial connection that is compliant with a version of the IEEE 1394 standard.

The I/O interface(s) 640 may also include one or more network interfaces that enable communications between computing devices in the system 600, or between the system 600 and other network-connected computing systems. The network interface(s) may include one or more network interface controllers (NICs) or other types of transceiver devices configured to send and receive communications over one or more communication networks using any network protocol.

Computing devices of the system 600 may communicate with one another, or with other computing devices, using one or more communication networks. Such communication networks may include public networks such as the internet, private networks such as an institutional or personal intranet, or any combination of private and public networks. The communication networks may include any type of wired or wireless network, including but not limited to local area networks (LANs), wide area networks (WANs), wireless WANs (WWANs), wireless LANs (WLANs), mobile communications networks (e.g., 3G, 4G, Edge, etc.), and so forth. In some implementations, the communications between computing devices may be encrypted or otherwise secured. For example, communications may employ one or more public or private cryptographic keys, ciphers, digital certificates, or other credentials supported by a security protocol, such as any version of the Secure Sockets Layer (SSL) or the Transport Layer Security (TLS) protocol.

The system 600 may include any number of computing devices of any type. The computing device(s) may include, but are not limited to: a personal computer, a smartphone, a tablet computer, a wearable computer, an implanted computer, a mobile gaming device, an electronic book reader, an automotive computer, a desktop computer, a laptop computer, a notebook computer, a game console, a home entertainment device, a network computer, a server computer, a mainframe computer, a distributed computing device (e.g., a cloud computing device), a microcomputer, a system on a chip (SoC), a system in a package (SiP), and so forth. Although examples herein may describe computing device(s) as physical device(s), implementations are not so limited. In some examples, a computing device may include one or more of a virtual computing environment, a hypervisor, an emulation, or a virtual machine executing on one or more physical computing devices. In some examples, two or more computing devices may include a cluster, cloud, farm, or other grouping of multiple devices that coordinate operations to provide load balancing, failover support, parallel processing capabilities, shared storage resources, shared networking capabilities, or other aspects.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any appropriate kind of digital computer. Generally, a processor may receive instructions and data from a read only memory or a random access memory or both. Elements of a computer can include a processor for performing instructions and one or more memory devices for storing instructions and data. Generally, a computer may also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, implementations may be realized on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any appropriate form of sensory feedback, e.g., visual feedback, auditory feedback, or tactile feedback; and input from the user may be received in any appropriate form, including acoustic, speech, or tactile input.

Implementations may be realized in a computing system that includes a back end component, e.g., as a data server, or that includes a middleware component, e.g., an application server, or that includes a front end component, e.g., a client computer having a graphical user interface or a web browser through which a user may interact with an implementation, or any appropriate combination of one or more such back end, middleware, or front end components. The components of the system may be interconnected by any appropriate form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some examples be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

1. A computer-implemented method performed by at least one processor, the method comprising:
receiving, by the at least one processor, items that are published on a network, each of the items including one or more tags specified by an author of a respective item;
analyzing, by the at least one processor, the items to determine a plurality of graphs, wherein each graph models co-occurrences, during a respective time period, of pairs of tags in the items, each of the graphs including:
a plurality of nodes, each node corresponding to a tag that is included in the items published during the respective time period; and
one or more edges, each edge having a weight that indicates a number of co-occurrences of a respective pair of tags in the items published during the respective time period;
generating, by the at least one processor, a model that describes one or more changes, over time, in the plurality of graphs; and
employing, by the at least one processor, the model to predict the number of future co-occurrences of at least one pair of tags in items that are subsequently published on the network.

2. The method of claim 1, wherein:
a first graph of the plurality of graphs models co-occurrences, during a first time period after an event, of the pairs of tags in the items; and
at least one second graph of the plurality of graphs models co-occurrences, during at least one second time period after the first time period, of the pairs of tags in the items.

3. The method of claim 2, wherein the model describes the one or more changes in the number co-occurrences of the at least one pair of tags following the event.

4. The method of claim 1, wherein the model is employed to predict how long a pair of tags exhibit at least one co-occurrence in the subsequently published items.

5. The method of claim 1, further comprising:
employing, by the at least one processor, the model to predict a future value that is created, over time, by at least one co-occurring pair of tags.

6. The method of claim 1, wherein the one or more tags include one or more hashtags.

7. The method of claim 1, wherein:
the at least one network includes a social network; and
the published items are published as one or more of a tweet, a post, a share, or a comment on the social network.

8. A system, comprising:
at least one processor; and
a memory communicatively coupled to the at least one processor, the memory storing instructions which, when executed by the at least one processor, cause the at least one processor to perform operations comprising:
receiving items that are published on a network, each of the items including one or more tags specified by an author of a respective item;
analyzing the items to determine a plurality of graphs, wherein each graph models co-occurrences, during a respective time period, of pairs of tags in the items, each of the graphs including:
a plurality of nodes, each node corresponding to a tag that is included in the items published during the respective time period; and
one or more edges, each edge having a weight that indicates a number of co-occurrences of a respective pair of tags in the items published during the respective time period;
generating a model that describes one or more changes, over time, in the plurality of graphs; and
employing the model to predict the number of future co-occurrences of at least one pair of tags in items that are subsequently published on the network.

9. The system of claim 8, wherein:
a first graph of the plurality of graphs models co-occurrences, during a first time period after an event, of the pairs of tags in the items; and
at least one second graph of the plurality of graphs models co-occurrences, during at least one second time period after the first time period, of the pairs of tags in the items.

10. The system of claim 9, wherein the model describes the one or more changes in the number co-occurrences of the at least one pair of tags following the event.

11. The system of claim 8, wherein the model is employed to predict how long a pair of tags exhibit at least one co-occurrence in the subsequently published items.

12. The system of claim 8, the operations further comprising:
employing the model to predict a future value that is created, over time, by at least one co-occurring pair of tags.

13. The system of claim 8, wherein the one or more tags include one or more hashtags.

14. The system of claim 8, wherein:
the at least one network includes a social network; and
the published items are published as one or more of a tweet, a post, a share, or a comment on the social network.

15. One or more computer-readable media storing instructions which, when executed by at least one processor, cause the at least one processor to perform operations comprising:
receiving items that are published on a network, each of the items including one or more tags specified by an author of a respective item;
analyzing the items to determine a plurality of graphs, wherein each graph models co-occurrences, during a respective time period, of pairs of tags in the items, each of the graphs including:
a plurality of nodes, each node corresponding to a tag that is included in the items published during the respective time period; and
one or more edges, each edge having a weight that indicates a number of co-occurrences of a respective pair of tags in the items published during the respective time period;
generating a model that describes one or more changes, over time, in the plurality of graphs; and
employing the model to predict the number of future co-occurrences of at least one pair of tags in items that are subsequently published on the network.

16. The one or more computer-readable media of claim 15, wherein:
a first graph of the plurality of graphs models co-occurrences, during a first time period after an event, of the pairs of tags in the items; and
at least one second graph of the plurality of graphs models co-occurrences, during at least one second time period after the first time period, of the pairs of tags in the items.

17. The one or more computer-readable media of claim 16, wherein the model describes the one or more changes in the number co-occurrences of the at least one pair of tags following the event.

18. The one or more computer-readable media of claim 15, wherein the model is employed to predict how long a pair of tags exhibit at least one co-occurrence in the subsequently published items.

19. The one or more computer-readable media of claim 15, wherein the one or more tags include one or more hashtags.

20. The one or more computer-readable media of claim 15, wherein:
the at least one network includes a social network; and
the published items are published as one or more of a tweet, a post, a share, or a comment on the social network.
